(19) United States
(12) Patent Application Publication
(10) Pub. No.: US 2008/0120454 A1
(43) Pub. Date: May 22, 2008

(54) Integrated hub control chip

(76) Inventors: Chi-Tung Chang, Taipei (TW); Shih-Min Lan, Taipei (TW); I-Chieh Lin, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/638,481

(22) Filed: Dec. 14, 2006

(30) Foreign Application Priority Data
Nov. 17, 2006 (TW) 95142642

(51) Int. Cl. G06F 3/00

(52) U.S. Cl. 710/316

(57) ABSTRACT

An integrated hub control chip is applied to a motherboard of an application system. The integrated hub control chip contains an upstream port transceiver, an upstream port controller, a relaying circuit unit, a keyboard control module, a digital camera control module, a storage medium control module, and a relaying circuit controller. The keyboard control module, the digital camera control module, and the storage medium control module are directly connected to the relaying circuit controller. The relaying circuit controller switches the transmission path of the relaying circuit unit according to the transmission speed of these control modules. The upstream port controller controls the transmission direction of the upstream port transceiver to accomplish the data communication with the motherboard. The objects of saving the circuit space of motherboard, reducing the hardware cost, and increasing the purposes and expansibility of the integrated hub control chip can therefore be achieved.

### BACKGROUND OF THE INVENTION

1. Field of the invention

The present invention relates to a hub control chip and, more particularly, to an integrated USB hub control chip.

2. Description of Related Art

In recent years, with fast development of science and technology, 3C products have changed with each passing day. Various computer peripheral products have been presented to the public like bamboo shoots after a spring rain. The transmission technology used between the host end and the device end has evolved constantly. The most widely used and the most stable transmission technique is the USB transmission technique for connection between peripheral devices and host systems. Not only has the USB transmission technique of simple design matured, but its speed can also meet the requirements of most peripheral devices. It has become the standard transmission manner adopted by mainstream products in the present market conditions.

The number of USB ports provided by personal computers, especially notebook computers, is limited. Not only the number of USB ports supported by the original motherboard is fixed, the outer appearance design has also to take the whole size into condition, hence even more limiting the number of USB ports provided.

Moreover, owing to the requirements of consumers for product functions, products developed and designed nowadays has to emphasize the integration of multiple functions and their supportability to increase the purchase motive of consumers. For instance, a notebook computer equipped with a floppy disk drive, PCMCIA interfaces and a CD drive is an intact equipment in early days. Today's notebooks, however, have to equip various wireless transmission techniques (e.g., IR, Bluetooth, and so on), flash card readers and even digital cameras to enhance the competitiveness of products. If various peripheral devices are designed with the USB transmission technique, although the control chip of each peripheral device is built in the notebook computers, not only the circuit space on the motherboard will be occupied, but the number of remaining USB transmission ports will also decrease.

FIG. 1 shows a block diagram of a prior art motherboard adopting a USB hub structure. As shown in FIG. 1, based on the USB specification, a hub control chip 10a contains a first upstream port 101a used to connect an I/O controller hub (ICH, also called south bridge) 20a provided by a motherboard 1a itself and a plurality of first downstream ports 102a each used to connect a second upstream port 301a in a peripheral control chip 30a. Each of the above upstream ports and downstream ports contains a port controller (not shown) to control the operation of the upstream port or the downstream port. The object of data transmission can thus be accomplished by bridging the I/O controller hub 20a and the peripheral control chips 30a.

Although the above solution can conquer the problem that the USB transmission ports provided by the I/O controller hub 20a of the motherboard 1a are occupied, not only the number of the peripheral control chips 30a does not decrease, but the circuit space of the hub control chip 10a has also to increase, hence being not able to effectively shrink the occupied space of the motherboard 10a. Moreover, because the hub control chip 10a communicates with each of the peripheral control chips 30a via the upstream port and the corresponding downstream port, it is necessary to design a port controller in the hub control chip 10a and the peripheral control chip 30a to control the operation of the upstream port and the downstream port, hence further increasing the cost burden in the hardware design.

### SUMMARY OF THE INVENTION

An object of the present invention is to make use of the characteristics of hardware circuits that can be used together to integrate a hub control chip and several peripheral control chips so as to save upstream ports (including port controllers) of the peripheral control chips and to reserve downstream ports of the hub control chip and USB ports owned by the I/O controller hub of the original motherboard for use by other external USB peripheral devices. Thereby, not only the circuit space of the motherboard can be saved, the hardware cost can be reduced, but the object of enhancing the purposes and expansibility of the integrated hub control chip can also be achieved.

To achieve the above object, the present invention provides an integrated hub control chip applied to a motherboard of an application system. The integrated hub control chip comprises an upstream port transceiver, an upstream port controller, a relaying circuit unit, a keyboard control module, a digital camera control module, a storage medium control module, and a relaying circuit controller. The upstream port transceiver is connected to an I/O controller hub (ICH) provided by the motherboard. The upstream port controller is used for controlling the transmission direction of the upstream port transceiver. The relaying circuit unit is electrically connected to the upstream port controller and providing at least a transmission path. The keyboard control module provides a key matrix connected to the application system. The digital camera control module provides an image capturing element connected to the application system. The storage medium control module provides at least a socket connected to the application system. The relaying circuit controller is electrically connected to the relaying circuit unit and used for switching the transmission path according to the transmission speed of the upstream port transceiver and the control modules, thereby conforming to mutual data transmission between the I/O controller hub and these control modules.

To further understand features and technical contents of the present invention please refer to the following detailed description and drawings related the present invention. However, the drawings are only to be used as references and explanations, not to limit the present invention.

### BRIEF DESCRIPTION OF THE DRAWINGS

The various objects and advantages of the present invention will be more readily understood from the following detailed description when read in conjunction with the appended drawing, in which:

FIG. 1 is a block diagram of a prior art motherboard adopting a USB hub structure;

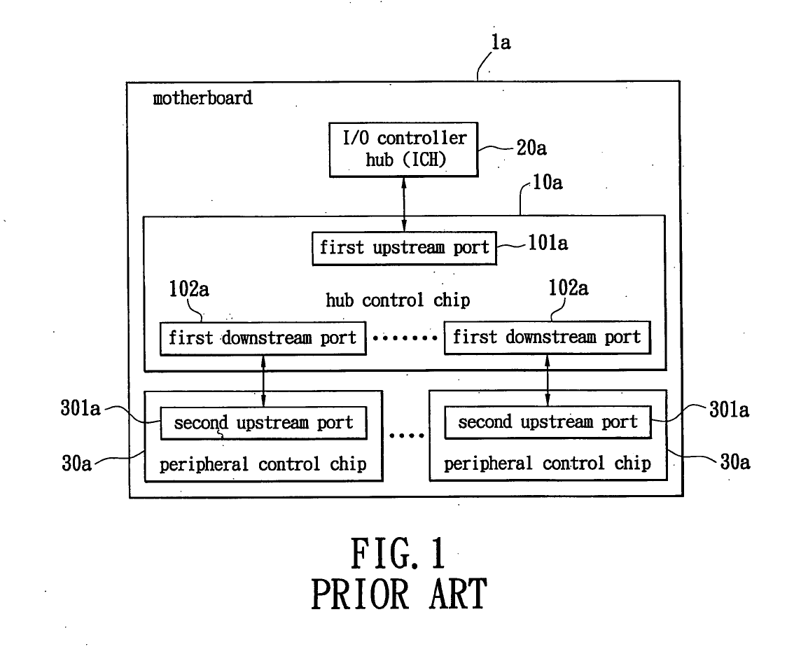

FIG. 2 is a block diagram of an integrated hub control chip according to an embodiment of the present invention; and

FIG. 3 is a perspective view showing the present invention is applied to a notebook computer.

### DETAILED DESCRIPTION OF THE PREFERRED EMBODIMENTS

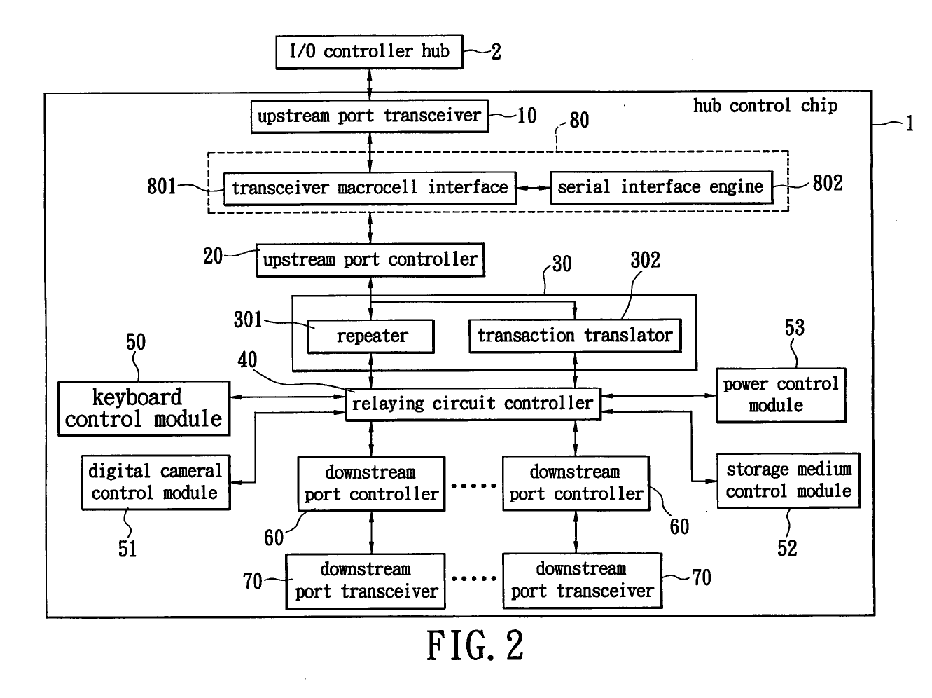

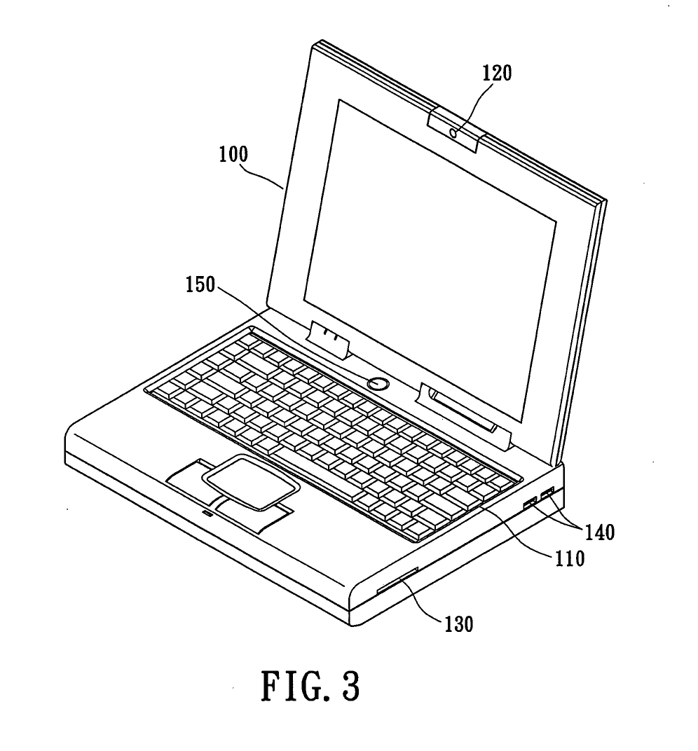

FIG. 2 is a block diagram of an integrated hub control chip according to an embodiment of the present invention. As shown in FIG. 2, a hub control chip 1 of the present invention is applied to a motherboard (not shown) of an application system. The hub control chip 1 comprises an upstream port transceiver 10, an upstream port controller 20, a relaying circuit unit 30, a relaying circuit controller 40, a keyboard control module 50, a digital camera control module 51, a storage medium control module 52, a power control module 53, a plurality of downstream port controllers 60, and a plurality of downstream port transceiver 70. Reference is also med to FIG. 3, which shows the present invention is applied to a notebook computer. The present invention will be exemplified with a notebook computer 100 as the application system.

The upstream port transceiver 10 is connected to an I/O controller hub (ICH) 2 provided by the motherboard. The upstream port controller 20 is used to control the data transmission direction of the upstream port transceiver 10 and the data access operation of the I/O controller hub 2. The downstream port transceivers 70 are connected to USB ports 140 of the notebook computer 100 and communicate with external USB peripheral devices via the USB ports 140, respectively. The downstream port controllers 60 are connected to the downstream port transceivers 70 to control the data transmission direction of the downstream port transceivers 70 and the data access operation of the USB peripheral devices, respectively.

The keyboard control module 50, the digital camera control module 51, the storage medium control module 52, and the power control module 53 are directly connected to the relaying circuit controller 40. The keyboard control module 50 provides a key matrix 110 connected to the notebook computer 100 for data input of users, and achieves data transmission with the I/O controller hub 2. The digital camera control module 51 provides an image capturing element 120 connected to the notebook computer 100 to control the operation of the image capturing element 120 for image capture. The image capturing element 120 can be a charge coupled device (CCD) or a contact image sensor (CIS). The storage medium control module 52 provides at least a socket 139 connected to the notebook computer 100. The socket 130 can be a single socket or a multi-in-one socket of memory card. Moreover, the storage medium control module 52 can further has a built-in flash memory (not shown), and a boot program is stored in the flash memory to be loaded for execution when the notebook computer 100 is booted in the USB boot mode. Besides, the power control module 53 provides at least a button switch 150 connected to the notebook computer 100 to control the power supply state of the motherboard via the button switch 150.

The relaying circuit unit 30 is electrically connected to the upstream port controller 20, and further contains a repeater 301 and a transaction translator 302 to produce at least a transmission path for each of the keyboard control module 50, the digital camera control module 51, the storage medium control module 52, and the power control module 53, and for the data transmission between the USB peripheral devices connected via the downstream port transceivers 70 and the I/O controller hub 2. The relaying circuit controller 40 is electrically connected to the relaying circuit unit 30 and used for switching the transmission path in the relaying circuit unit 30 according to the transmission speed of the upstream port transceiver 10 and these control modules. The upstream port transceiver 10 operates at the same transmission speed according to the specification of the connected I/O controller hub 2. The transmission speed can be high-speed, full-speed, and low-speed. If the control module or the USB peripheral device have the same transmission speed with the upstream port transceiver 10, the relaying circuit controller 40 switches the relaying circuit unit 30 to use the repeater 301 for data transmission. Contrarily, If the control module or the USB peripheral device have a different transmission speed from the upstream port transceiver 10, the relaying circuit controller 40 switches the relaying circuit unit 30 to use the transaction translator 302 for data transmission.

In order to conform to the USB specification, the hub control chip 1 further comprises an interface controller 80, which strides over the upstream port transceiver 10 and the upstream port controller 20 and is used to process interface information between the hub control chip 1 and the I/O controller hub 2. The interface controller 80 further comprises a transceiver macrocell interface 801 and a serial interface engine 802. The transceiver macrocell interface 801 is used for processing the operations such as serial/parallel conversion, encoding/decoding and bit fill. The serial interface engine 802 is used for defining the transmission protocol conforming to the USB specification.

To sum up, the present invention not only can increase the number of USB ports provided by the I/O hub controller 2 of the original motherboard, but can also integrate several control modules to improve the use of the USB hub control chip that is originally used only for increasing the number of USB ports, thereby becoming an application-specific IC (ASIC) with built-in multiple functions and also achieving the object of increasing the purposes and expansibility. Moreover, the number of required peripheral controllers can be reduced to save the circuit space of the motherboard and lower the design and development cost.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

What is claimed is:

1. An integrated hub control chip applied to a motherboard of an application system, said integrated hub control chip comprising:
an upstream port transceiver connected to an I/O controller hub of said motherboard;
an upstream port controller for controlling the transmission direction of said upstream port transceiver;
a relaying circuit unit electrically connected to said upstream port controller and providing at least a transmission path;
a keyboard control module for providing a key matrix connected to said application system;
a digital camera control module for providing an image capturing element connected to said application system;
a storage medium control module for providing at least a socket connected to said application system; and
a relaying circuit controller electrically connected to said relaying circuit unit and switching said transmission path according to the transmission speed of said upstream port transceiver and said control modules.

2. The integrated hub control chip as claimed in claim 1, wherein said application system is a notebook computer.

3. The integrated hub control chip as claimed in claim 1, wherein said relaying circuit unit further comprises:
a repeater for providing a transmission path to be switched by said relaying circuit controller when said control modules and said upstream port transceiver have the same transmission speed; and
a transaction translator for providing a transmission path to be switched by said relaying circuit controller when said control modules and said upstream port transceiver have different transmission speeds.

4. The integrated hub control chip as claimed in claim 1, wherein said storage medium control module further has a built-in flash memory, and a boot program is stored in said flash memory to be loaded for execution when said application system is booted.

5. The integrated hub control chip as claimed in claim 1, wherein said socket is a single socket or a multi-in-one socket of memory card.

6. The integrated hub control chip as claimed in claim 1, wherein the transmission speed is high-speed, full-speed or low-speed.

7. The integrated hub control chip as claimed in claim 1, wherein said upstream port transceiver operates at the same transmission speed according to the specification of said I/O controller hub.

8. The integrated hub control chip as claimed in claim 1 further comprises: P1 a plurality of downstream port transceivers respectively connected to an external USB peripheral device via a USB port; and
a plurality of downstream port controller connected to said relaying circuit controller and controlling the transmission direction of said downstream port transceivers.

9. The integrated hub control chip as claimed in claim 1 further comprises a power control module, wherein said power control module is electrically connected to said relaying circuit controller and provides at least a button switch connected to said application system to control the power supply state of said motherboard.

10. The integrated hub control chip as claimed in claim 1 further comprises an interface controller, wherein said interface controller strides over said upstream port transceiver and said upstream port controller and processes interface information with said I/O controller hub.

11. The integrated hub control chip as claimed in claim 10, wherein said interface controller further comprises:
a transceiver macrocell interface for processing the operations such as serial/parallel conversion, encoding/decoding and bit fill; and
a serial interface engine for defining the USB transmission protocol.
